(19) United States
(12) Patent Application Publication
(10) Pub. No.: US 2003/0179521 A1
(43) Pub. Date: Sep. 25, 2003

(54) Electronic microcomponent incorporating a capacitive structure and fabrication process

(76) Inventor: Lionel Girardie, Eybens (FR)

Correspondence Address: HESLIN ROTHENBERG FARLEY & MESITI PC, 5 COLUMBIA CIRCLE, ALBANY, NY, 12203, US

(21) Appl. No.: 10/379,754

(22) Filed: Mar. 5, 2003

(30) Foreign Application Priority Data
Mar. 20, 2002 (FR) 02.03442
Mar. 20, 2002 (FR) 02.03445

(51) Int. Cl. H02H 7/16

(52) U.S. Cl. 361/15

(57) ABSTRACT

Electronic microcomponent based on a substrate and incorporating a capacitive structure produced on top of a metallization level present in the substrate, said capacitive structure comprising two electrodes, wherein:

the first electrode comprises a plurality of metal lamellae stacked on top of one another and separated from one another by narrower sections produced from the same metal; and

the second electrode overlaps the first electrode, by comprising a plurality of lamellae interleaved between the lamellae of the first electrode.

### TECHNICAL FIELD

The invention relates to the technical field of microelectronics. More precisely, it relates to electronic microcomponents incorporating one or more capacitive structures.

These capacitive structures may form microcapacitors. These microcapacitors are therefore intended to be produced using what are called post-processing techniques, meaning that these microcapacitors can be produced on the upper face of existing microcomponents. These components may especially be used in radiofrequency applications, it being possible for the microcapacitors to be used, for example, as decoupling capacitors.

These capacitive structures may also be intended to be produced inside the actual microcomponent, on top of metallization levels directly connected to the terminals of the transistors and other semiconductor structures. These capacitive structures can then be used in particular as embedded dynamic memory cells (embedded DRAM).

The invention relates more specifically to the structure of such a capacitor, for the purpose of very greatly increasing its “capacitance”, that is to say its capacitance per unit area, and to do so without excessively increasing either the fabrication costs or the area used on the microcomponent.

### PRIOR ART

The production of microcapacitors or capacitive structures on semiconductor substrates has already been the subject of considerable development.

Various technologies have already come to light, and especially those that make it possible to produce capacitive structures formed from two electrodes formed by metal layers separated by a layer of insulating material or dielectric. This type of capacitor is generally one with what is termed a MIM (Metal Insulator Metal) structure. The invention relates more particularly to this type of capacitive structure.

Among existing solutions, that disclosed in document FR 2 801 425 relates to a microcapacitor whose two electrodes are formed by flat metal layers. In this case, the capacitance value of the capacitor depends essentially on the type of dielectric used and on the facing area of the two metal electrodes. In other words, the “capacitance”, or the capacitance per unit area, is predominantly fixed by the thickness of the insulating layer and its relative permittivity. Thus, to increase the capacitance value, it is necessary either to choose materials with a very high relative permittivity or to reduce the distances between the electrodes, with the risk of breakdown phenomena, or even tunnel effects, occurring. In other words, the capacitors produced according to the structure described in that document are limited in terms of capacitance.

The Applicant has disclosed, in French patent application No. 02/01618, a novel capacitive structure produced on a metallization level of an electronic component. Each electrode of this capacitive structure comprises a plurality of metal lamellae that are perpendicular to the principal plane of the substrate.

The Applicant has also disclosed, in French patent application No. 02/02461, another capacitive structure comprising a stack of superposed metal lamellae offset with respect to one another, the parts in contact forming a common trunk.

One of the objectives of the invention is to provide a capacitive structure which can be produced on the final visible metallization level of an electronic microcomponent and which has a capacitance value greater than the values usually observed.

### SUMMARY OF THE INVENTION

The invention therefore relates to an electronic microcomponent based on a substrate and incorporating a capacitive structure produced on top of a visible metallization level present on the substrate. The capacitive structure comprises two electrodes, wherein:

the first electrode comprises a plurality of metal lamellae stacked on top of one another and separated from one another by narrower sections produced from the same metal, forming, with the portions of the metal lamellae that overlap them, a central trunk; and

the second electrode overlaps the first electrode, by comprising a plurality of lamellae interleaved between the lamellae of the first electrode.

In other words, the first electrode forms a tree structure comprising a trunk from which lamellae extend on each side. The trunk is formed by the superposition of the central parts of the lamellae and the narrower sections.

The second electrode overlaps the first, by forming a plurality of lamellae that are interleaved between the ends of the lamellae of the first electrode. The facing area of each of the electrodes is therefore particularly high.

For the same area occupied on the substrate, this facing area may be increased by increasing the number of lamellae of each electrode, which therefore allows the capacitance to be increased as desired.

In practice, the capacitors according to the invention exhibit excellent electrical properties and especially when metals of very high conductivity are used, i.e. metals having a resistivity of less than 5 μΩ.cm. The advantages of a very low resistivity are manifested in particular by low heat-up of the capacitive structure in dynamic mode and also good high-frequency operation and an appreciable thermal conductivity.

In practice, the electrodes are separated by a dielectric layer produced from materials which are advantageously chosen from the group of ferroelectric and/or pyroelectric oxides. The following are known from among these ferroelectric oxides: hafnium dioxide, tantalum pentoxide, zirconium dioxide, lanthanum oxides, diyttrium trioxide, alumina, titanium dioxide, and strontium titanates and tantalates (STO), barium strontium titanates (BST), strontium bismuth tantalates (SBT), and lead zirconate titanates (PZT), rare-earth (lanthanide)-doped lead zirconate titanates (PLZT), strontium bismuth niobates (SBN), strontium bismuth tantalate niobates (SBTN), barium yttrium cuprates and manganese alkoxides Me₂MnO₃.

This dielectric may be deposited either as a uniform layer of the same material or of an alloy of several of these materials.

However, in a preferred embodiment, the dielectric layer may also consist of the superposition of elementary layers of different materials forming a nanolaminate structure. In this case, each of the layers is of very small thickness, of the order of a few ångstroms to a few hundred ångstroms.

In a preferred embodiment, the stoichiometry of the materials varies from one elementary layer to another in the nanolaminate structure. Thus, by varying the stoichiometry of each layer, oxygen concentration gradients (and concentration gradients of the other materials used) are created over a few atomic layers. The variation in band structure of each elementary layer of the nanolaminate structure consequently modifies the overall band structure of the ferroelectric and pyroelectric oxide compounds and alloys over only a few atomic layers.

In this way, particularly high relative permittivity values are obtained, this being conducive to increasing the capacitance.

In practice, the surface of each electrode is preferably coated with a layer of an oxygen diffusion barrier material, typically based on titanium nitride, tungsten nitride, tantalum nitride or else one of the following materials: TaAlN, TiAlN, Mo, MoN, W, Os, Rh, Re, Ru, CoW, TaSiN, TiSiₓ, WSiₓ and alloys of transition metals with boron, of the TiB₂ type, or with carbon, of the TiC type, depending on the desired application.

The invention also relates to processes for fabricating such a capacitive structure. This capacitive structure is fabricated on an electronic microcomponent, on top of the final visible metallization level produced in the substrate.

According to a first method of implementing the invention, the process comprises the following steps, consisting in:

depositing, on top of the metallization level, a first metal layer intended to form the bottom part of one of the two electrodes of the capacitive structure;

depositing, on top of said first metal layer, a second metal layer of smaller width;

depositing, on top of two metal layers, a layer of a polymer material in which the upper face is able to serve as a support for a subsequent metal coating;

repeating the three previous deposition steps so as to obtain a tree structure forming the first electrode, comprising a central trunk and a plurality of lamellae extending from said central trunk;

removing all of the layers of polymer material;

depositing, over the entire visible surface of the first electrode, a dielectric in the form of a nanolaminate structure; and

depositing, over the first electrode, a conducting material that will be inserted between the metal layers of the first electrode so as to form the second electrode.

According to a second method of implementing the invention, the process comprises the following steps, consisting in:

depositing, on top of the metallization level, a first metal layer intended to form the bottom part of one of the two electrodes of the capacitive structure;

depositing, on top of the metal layer, a layer of a polymer material whose upper face is able to serve as a support for a subsequent metal coating;

repeating the two previous deposition steps so as to obtain a stack of metal layers separated by a layer of polymer material;

producing, in the center of the stack, a trench hollowed out so as to reveal the first metal layer;

depositing, in said trench, a metal identical to that of the stacked layers so as to obtain a tree structure forming the first electrode, comprising a central trunk and a plurality of lamellae extending from said central trunk;

removing all of the layers of polymer material;

depositing, over the entire visible surface of the first electrode, a dielectric in the form of a nanolaminate structure; and

depositing, over the first electrode, a conducting material that will be inserted between the metal layers of the first electrode, so as to form the second electrode.

### BRIEF DESCRIPTION OF THE DRAWINGS

The manner in which the invention is realized and the advantages which stem therefrom will be clearly apparent from the following description of the embodiments, supported by the appended FIGS. 1 to 27, which are schematic sectional representations of the upper region of an electronic microcomponent and of the capacitive structure according to the invention, during the various steps of the production processes. More specifically, FIGS. 1 to 5 and 13 to 18 are views common to the two processes described in detail. FIGS. 6 to 12, on the one hand, and 19 to 27, on the other, are specific to one particular embodiment.

Of course, these drawings are given merely as an illustration, and the dimensions of the various layers and actual elements involved in the invention may differ from those shown in the figures, for the sole purpose of making the invention understandable.

### MANNER OF REALIZING THE INVENTION

Described below are several particular production processes which allow microcapacitor structures according to the invention to be obtained. Certain steps in the process described may nevertheless be regarded as accessory or simply useful and advantageous for improving certain performance characteristics, without being absolutely necessary for remaining within the scope of the invention.

Thus, a microcapacitor according to the invention may be produced on a microcomponent (1) as illustrated in FIG. 1. The substrate (2) of this microcomponent comprises, in the upper part, one or more metallization levels (3) which may be connected to active regions within the microcomponent or else to interconnect studs emerging on the upper face of the substrate. In the embodiment illustrated, this is a metallization level located on the upper face of the substrate. More specifically, the upper face of the substrate is coated with a passivation layer (8), typically made of SiO₂ or SiON.

Thus, in the first step illustrated in FIG. 1, a resist layer (5) is deposited, an aperture (6) being defined in said resist layer by lithography. This aperture makes it possible to carry out localized etching of the passivation layer (8) so as to reveal the subjacent metallization level (3). The passivation layer (8) may, when it is made of SiON, be etched by a conventional chemical etching process using a CF₄/O₂ or CF₄/H₂ mixture or else by a technique of the RIE (Reactive Ion Etching) type, or by using a radiofrequency plasma.

The process continues with a cleaning step for removing any remaining trace of SiON or of the products used for etching it. This cleaning may, for example, be carried out using a solution sold under the reference ACT 970 by Ashland. This cleaning may be followed by prerinsing, with dissolution of carbon dioxide or ozone by bubbling, with a hydroxycarboxylic acid such as citric acid or oxalic acid.

Thereafter, a copper diffusion barrier layer (10) is deposited, as illustrated in FIG. 2. This diffusion barrier layer serves to improve the resistance to electromigration and to oxygen diffusion. This layer may be deposited by an ALD (Atomic Layer Deposition) technique. Such a technique gives this barrier layer (10) good thickness uniformity and excellent integrity.

Thereafter, a copper primer layer (9) is also deposited, so as to allow subsequent deposition by electrolytic techniques.

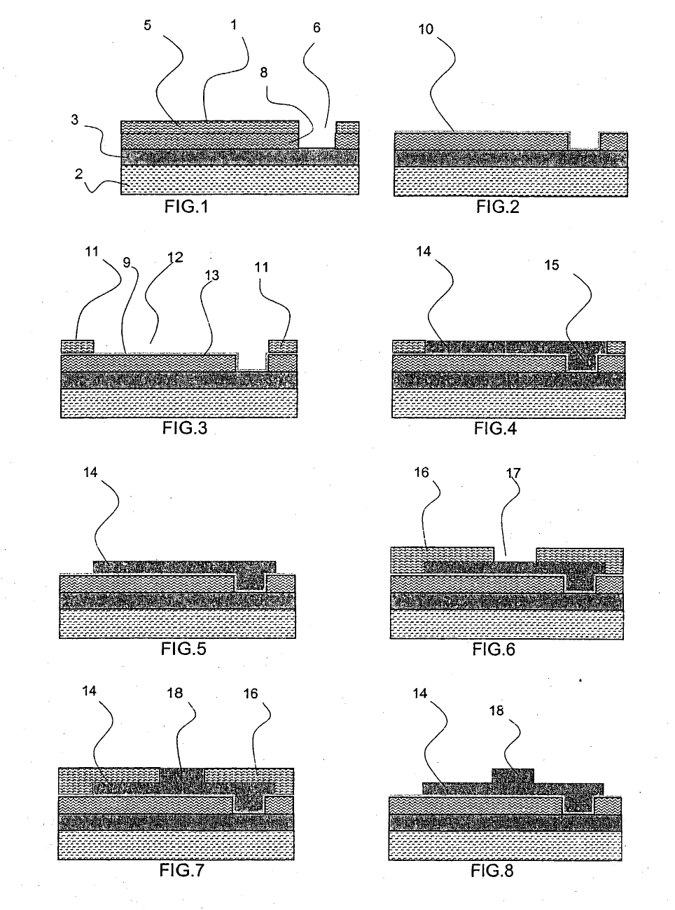

Next, and as illustrated in FIG. 3, a second resist layer (11) is deposited, which is then irradiated and then partly removed in order to define a housing (12), the bottom (13) of which exposes the copper primer layer (9).

Next, and as illustrated in FIG. 4, copper is electrolytically deposited so as to form the first broad lamella (14) of the first electrode. The first electrolytic deposition is also carried out until contact with the metallization level (3), so that the first electrode is electrically connected to the metallization level by the stud (15).

Next, and as illustrated in FIG. 5, the resist regions (11) defining the housing, which allowed the first lamella (14) to be obtained, are removed.

Next, two separate processes are used to define capacitive structures of similar architectures, but using different steps, these structures also being for different applications.

First Embodiment

Thus, to produce capacitive structures used as capacitors, for example decoupling capacitors, the procedure as illustrated in FIGS. 6 to 18 is carried out. Starting from the intermediate structure of FIG. 5, and as illustrated in FIG. 6, a resist (16) is deposited and then etched by lithography in order to define a housing (17) corresponding to the central trunk of the first electrode. For example, the resist AZ4620 manufactured by Clariant, which has specific characteristics for resisting acid copper salt baths, may be used.

Next, and as illustrated in FIG. 7, copper is electrolytically deposited on top of the visible region of the first lamella (14), also made of copper, in order to form the central trunk (18).

Next, and as illustrated in FIG. 8, the resist (16) is removed in order to expose the upper face of the first lamella (14) and the first central trunk (18).

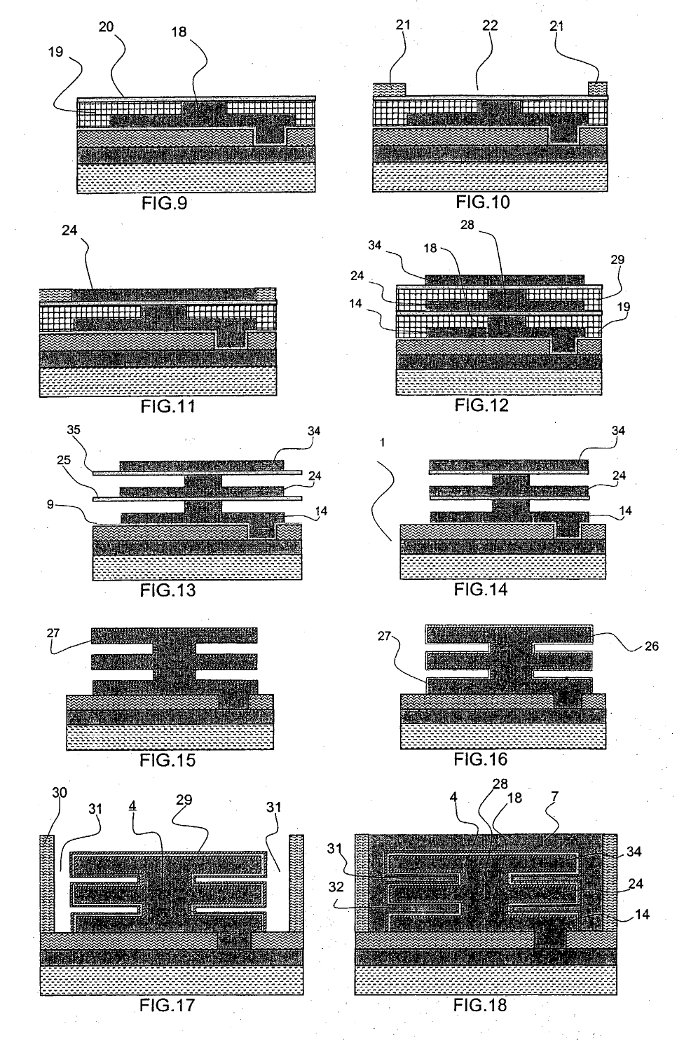

Next, and as illustrated in FIG. 9, a polymer material (19), typically a polyimide or benzocyclobutene, is deposited. This polymer material is deposited using spin-on deposition techniques. This polymeric layer (19) is then planarized, for example by CMP. This planarization is carried out so that the layer (19) is flush with the upper face of the first central trunk and so as to expose this face in order to receive, as illustrated in FIG. 9, a layer (20) of TiCu deposited with a thickness of around 200 Å. This layer serves both as a protective layer for the polymeric layer (19) and as copper primer layer.

Next, and as illustrated in FIG. 10, a resist layer (21) is deposited. This resist layer is then removed in a region defining a housing (22) for depositing a second copper lamella (24), as illustrated in FIG. 11, this being obtained by electrolytic techniques.

The various steps for depositing the lamellae (14, 24, 34), the central trunks (18, 28) and the polymeric layer (19, 29) are repeated so as to end up with a structure as illustrated in FIG. 12. Of course, the number of lamellae illustrated in FIG. 12 is only indicative, it being possible to produce structures comprising a larger number of lamellae.

Next, the resist layers having been used to define the upper lamella (34) of the first electrode are removed.

Next, and as illustrated in FIG. 13, the various polymeric layers (19, 29) are removed. This removal is accomplished by various techniques and especially by processes commonly known as “ashing”, using for example oxygen plasmas in combination with suitable chemical compositions. It is possible, but not essential, to follow this with an annealing heat treatment. This treatment may be carried out batchwise, at a temperature close to 120° C. for about 30 minutes. It is also possible to carry out a rapid annealing step (or RTP).

After the polymeric materials have been removed, the structure obtained has the remainders of the copper primer layers (9, 25, 35), that had been deposited in succession and are located at the lower level of each lamella (14, 24, 34).

These various primer layer excrescencies are removed, as illustrated in FIG. 14, by selectively etching the copper. The solution used for the etching may, for example, be based on ammonium persulfate (APS) at acid pH, used at 45° C. The substantial selectivity (of around 1:50) of this etching results in particular from the fact that the crystal structure of the primer layer (9, 25, 35) differs from that of the electrolytically deposited copper lamellae (14, 24, 34). After this chemical treatment an annealing heat treatment is then carried out so as to make the copper structure homogeneous, especially between the various primer layer residues, present under the lower faces of the lamellae, and the remainder of the copper lamellae. This annealing may be carried out in hydrogen and argon at about 400° C. for about 6 hours.

Next, as illustrated in FIG. 15, an oxygen diffusion barrier layer (27) is deposited by ALD, as explained above. This diffusion barrier layer (27) also acts as primer layer for the deposition of the subsequent layers.

Next, as illustrated in FIG. 16, a dielectric layer consisting of a nanolaminate structure (26) is deposited.

More specifically, the nanolaminate structure deposited is produced from various layers of ferroelectric or pyroelectric oxides. In a first particular illustrative example, the nanolaminate structure (26) may comprise a stack of eight different layers, namely:

the first layer, having a thickness of 5 to 10 Å, is produced from AlₓO₃₋ₓ, with x between 0 and 3;

the second layer has a thickness of around 10 to 15 Å and is produced from Ta_{z-2}O_{5-z}Al₂Oₓ, with z between 0 and 2;

the third layer, having a thickness of around 15 to 20 Å, is produced from TiO₂AlₓO_{3+y}, with y between 0 and 3;

the fourth layer, having a thickness of around 40 to 100 Å, is produced from TiO_{y-z}Ta_{z-2}O_{5+z};

the fifth layer, having a thickness of 60 to 200 Å, is produced from TiO_{y}Ta_{3-z}O_{z}; and

the sixth, seventh and eighth layers are identical to the third, second and first layers, respectively.

The nanolaminate structure thus obtained has a thickness of between 200 and 400 Å. The relative permittivity of this layer is around 23.

In a second embodiment, the nanolaminate structure (26) may comprise a stack of five different layers, having a thickness of at least three atomic layers, namely:

the first layer, having a thickness of 5 to 10 Å, is produced from Hf_{y}Al_{z}O₃₋ₓ, with x between 0 and 3, y between 0 and 2 and z between 1 and 10;

the second layer has a thickness of around 4 to 15 Å and is produced from Hf_{y+n}Al_{z}O₃₋ₓ, with z between 0 and 2, x between 1+n and 3+n, y between 1+n and 2+n and n being between 1 and 8;

the third layer has a thickness of around 4 to 20 Å and is produced from Hf_{y+2n}Al_{z-n}O₃₋ₓ with z between 0 and 2, x between 1+n and 3+n, y between 1+n and 2+n and n being between 1 and 8;

the fourth layer has a thickness of around 4 to 15 Å and is produced from Hf_{y+n}Al_{z}O₃₋ₓ, with z between 0 and 2, x between 1+n and 3+n, y between 1+n and 2+n and n being between 1 and 8; and

the fifth layer, having a thickness of around 5 to 10 Å, is produced from Hf_{y}Al_{z}O₃₋ₓ, with x between 0 and 3, y between 0 and 2 and z between 1 and 10.

The nanolaminate structure thus obtained has a thickness of between 20 and 200 Å. The relative permittivity of this layer is around 18.

Of course, the nanolaminate structures described above are nonlimiting examples, in which certain elements may be substituted without departing from the scope of the invention.

Next, an oxygen diffusion barrier layer (29) similar to the abovementioned layer (27) is deposited on top of the nanolaminate structure.

Next, and as illustrated in FIG. 17, a structuring layer (30), typically obtained from benzocyclobutene (BCB), from a polyimide or from Parylene®, is deposited.

This structuring layer (30) is etched to define a housing (31) around the first electrode (4).

The process continues with the deposition of a new primer layer on the surface of the first electrode (4), so as to allow subsequent electrolytic deposition in order to form a damascene structure, producing the second electrode (7) as illustrated in FIG. 18.

Optional further steps of passivation or production of a connection surface on the second electrode may be carried out.

As an example, the capacitor structure illustrated in FIG. 18 may have a capacitance of around 100 nanofarads/mm². In this case, the lamellae have dimensions of the order of one micron to about 10 microns.

Second Embodiment

To produce capacitive structures used for example as embedded DRAM cells, certain intermediate steps, after the operations resulting in the intermediate structure shown in FIG. 5, are carried out as illustrated in FIGS. 19 to 33.

Thus, starting from the intermediate structure shown in FIG. 5, and as illustrated in FIG. 19, a polymer material (119), such as that already described in relation to FIG. 9, is deposited. It is deposited with a thickness corresponding approximately to the space that it is desired to form between the successive lamellae of the first electrode.

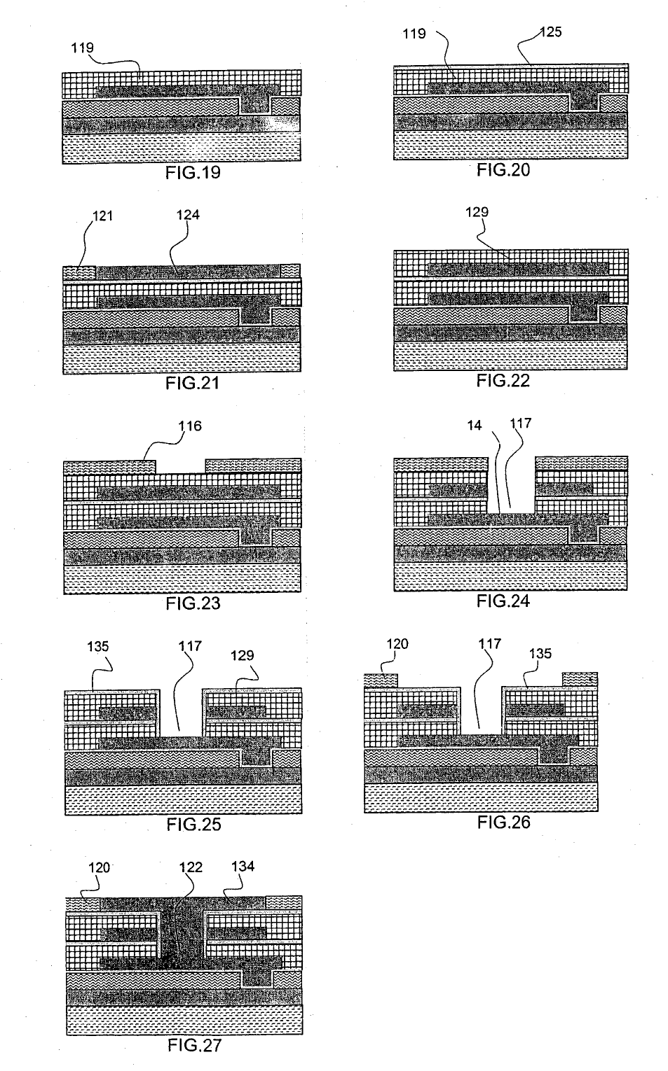

Next, as illustrated in FIG. 20, a layer (125) of TiCu is deposited with a thickness of around 200 Å. This layer serves both as layer to protect the polymeric layer (119) and as copper primer layer. This primer layer (125) is then planarized, for example by CMP.

Next, and as illustrated in FIG. 21, a resist layer (121) is deposited. This resist layer is then removed in a region for defining a housing for the deposition of a second copper lamella (124) which is obtained by electrolytic techniques.

Next, as illustrated in FIG. 22, a further polymeric layer (129) is deposited. The operations of depositing a metal layer and depositing a polymeric layer may be repeated in succession as many times as required. Of course, the number of lamellae illustrated in FIG. 22 is purely indicative, and it is possible to produce structures comprising a larger number of lamellae.

Next, as illustrated in FIG. 23, a resist layer (116) is deposited. This resist layer is then removed in a central region located plumb with the future central trunk of the first electrode.

As illustrated in FIG. 24, the polymeric layers (119, 129) and the metal lamella (124) are then etched to form an aperture (117). This aperture (117) exposes the upper face of the first metal lamella (14).

Next, and as illustrated in FIG. 25, a copper primer layer (135) is deposited, said primer layer covering the upper face of the polymeric layer (129) and the sidewalls of the aperture (117).

Next, a resist layer (120) is deposited on the primer layer (135) so as to define the housing for the future upper lamella of the first electrode, as illustrated in FIG. 26.

Next, and as illustrated in FIG. 27, copper is electrolytically deposited so as to fill the housing (117) and form the central trunk (122) of the first electrode, and also the upper lamella (134).

Next, the resist regions (120) having been used to define the upper lamella (134) of the first electrode are removed.

Thereafter, the process continues in the same way as described in the case of the first embodiment, in relation to FIGS. 13 to 18.

It is apparent from the foregoing that the capacitors according to the invention can be obtained with very high capacitance values without incurring high costs as regards their fabrication process.

1. An electronic microcomponent based on a substrate and incorporating a capacitive structure produced on top of a metallization level present in the substrate, said capacitive structure comprising two electrodes, wherein:
the first electrode comprises a plurality of metal lamellae stacked on top of one another and separated from one another by narrower sections produced from the same metal; and
the second electrode overlaps the first electrode, by comprising a plurality of lamellae interleaved between the lamellae of the first electrode.

2. The microcomponent as claimed in claim 1, wherein the metal used has a resistivity of less than 5 μΩ.cm.

3. The microcomponent as claimed in claim 1, wherein the electrodes are separated by a layer of a dielectric chosen from the group of ferroelectric and/or pyroelectric oxides.

4. The microcomponent as claimed in claim 3, wherein the dielectric layer is produced by the superposition of elementary layers of different compositions, forming a nanolaminate structure.

5. The microcomponent as claimed in claim 4, wherein the stoichiometry of the materials varies from one layer of the nanolaminate structure to another.

6. A process for producing a capacitive structure on an electronic microcomponent, said capacitive structure being produced on top of the final visible metallization level present in the substrate, which comprises the following steps, consisting in:
depositing, on top of the metallization level, a first metal layer intended to form the bottom part of one of the two electrodes of the capacitive structure;
depositing, on top of said first metal layer, a second metal layer of smaller width;
depositing, on top of the two metal layers, a layer of a polymer material whose upper face is able to serve as a support for a subsequent metal coating;
repeating the three previous deposition steps so as to obtain a tree structure forming the first electrode, comprising a central trunk and a plurality of lamellae extending from said central trunk;
removing ail of the layers of polymer material;
depositing, over the entire visible surface of the first electrode, a dielectric in the form of a nanolaminate structure; and
depositing, over the first electrode, a conducting material that will be inserted between the metal layers of the first electrode so as to form the second electrode.

8. A process for producing a capacitive structure on an electronic microcomponent, said capacitive structure being produced on top of the final visible metallization level present in the substrate, which comprises the following steps, consisting in:
depositing, on top of the metallization level, a first metal layer intended to form the bottom part of one of the two electrodes of the capacitive structure;
depositing, on top of the metal layer, a layer of a polymer material whose upper face is able to serve as a support for a subsequent metal coating;
repeating the two previous deposition steps so as to obtain a stack of metal layers separated by a layer of polymer material;
producing, in the center of the stack, a trench hollowed out so as to reveal the first metal layer;
depositing, in said trench, a metal identical to that of the stacked layers so as to obtain a tree structure forming the first electrode, comprising a central trunk and a plurality of lamellae extending from said central trunk;
removing all of the layers of polymer material;
depositing, over the entire visible surface of the first electrode, a dielectric in the form of a nanolaminate structure; and
depositing, over the first electrode, a conducting material that will be inserted between the metal layers of the first electrode, so as to form the second electrode.
